(19) United States
(12) Patent Application Publication
(10) Pub. No.: US 2002/0180095 A1
(43) Pub. Date: Dec. 5, 2002

(54) Thermally conductive carbon fiber extrusion compounder and method of using same

(76) Inventor: Steven O. Berard, Warwick, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/157,612

(22) Filed: May 29, 2002

Related U.S. Application Data
(60) Provisional application No. 60/294,086, filed on May 29, 2001.

(51) Int. Cl. B29C 47/06; B29C 45/00

(52) U.S. Cl. 264/143; 264/171.13; 264/237; 264/328.1

(57) ABSTRACT

The present invention discloses the extrusion of a thermally conductive polymer composition containing a continuous core of carbon fiber reinforcing. The material is created in a machine that is configured to hold a spool containing a continuous strand of carbon fiber core material. The carbon fiber strand is unrolled off the spool and is fed into a preheating chamber to bring the temperature of the strand to a pre-designated level. The strand is then fed into a port in an extruding head on a pressure extruding machine. A molten polymer matrix is also fed into the extruding head thereby extruding the polymer matrix onto, around and between the individual carbon fibers contained in the strand. The singular extruded composite strand that emerges from the extrusion head is then cooled and deionized before cutting the composite strand into pellets of a desired length for further processing and use as injection molding feedstock. The resulting composite pellets include continuous fiber reinforcing with fiber lengths that extend for the entire length of the pellet.

### PRIORITY CLAIM TO EARLIER FILED APPLICATION

This application is related to and claims priority from earlier filed provisional patent No. 60/294,086, filed May 29, 2001.

### BACKGROUND OF THE INVENTION

The present invention relates to highly thermally conductive extruded material. More specifically, the present invention relates to a material and a method for manufacturing a thermally conductive polymer material for use as injection molding feedstock in high thermal conductivity applications.

In the thermal transfer industries, it has been well known to employ metallic materials in the manufacture of parts for thermal conductivity applications, such as heat dissipation for cooling semiconductor device packages. For these applications, such as heat sinks, the metallic material typically is tooled or machined from bulk metals into the desired configuration. However, such metallic conductive articles are typically very heavy, costly to machine and are susceptible to corrosion. Further, the geometries of machined metallic heat dissipating articles are very limited to the inherent limitations associated with the machining or tooling process. As a result, the requirement of use of metallic materials, which are machined into the desired form, place severe limitations on design geometries. This is particularly problematic when it is known that certain geometries, simply by virtue of their design, realize better efficiency but are not attainable due to the limitations in machining metallic articles.

It is also widely known in the prior art that improving the overall geometry of a heat-dissipating article can greatly enhance the overall performance of the article even if the base material from which the part is manufactured is the same. Therefore, the need for improved heat transfer geometries have necessitated the development of an alternative to the machining of bulk metallic materials. To meet this need, attempts have been made in the prior art to provide molded compositions that include conductive filler material therein to provide the necessary thermal conductivity. As a result, the ability to mold a conductive composite has enabled the design of more complex part geometries to realize improved performance of the part.

The attempts in the prior art included the employment of a polymer base matrix loaded with a granular material, such as boron nitride grains. Also, attempts have been made to provide a polymer base matrix loaded with long fibrous filler materials. While these prior art compositions are moldable into complex geometries, they still do not approach the desired performance levels found in metallic machined parts. In addition, the prior art thermally plastic materials are undesirable because they are typically very expensive to manufacture and employ very expensive filler materials. Still further, these conductive composite materials must be molded with extreme precision due to concerns of long fiber filler alignment during the molding process. Even with precision molding and design, inherent problems of fluid turbulence and filler collisions within the mold due to complex product geometries make it impossible to position the filler ideally, thus causing the composition to perform at a less than desirable level.

The typical injection molding process employs a pelletized thermosetting polymer feed stock. This process creates further complication when the use of long fibrous fillers is desired. If the fiber filler is incorporated into the polymer at the time of injection molding the part by mixing the fibers into the base polymer during the melting process, many of the fibers are broken by the turbulence of the mixing process. If preformed pellet feed stock containing fiber filler is used, the length of fibers contained therein are often shorter than the entire length of the pellet material and generally have an unpredictable overall length distribution. This is typically the result because the pellets are formed using the method described above where random length filler fibers are added to a base polymer matrix material and mixed by a destructive screw or auger and then injection molded into a strand that is pelletized providing a random fiber distribution throughout the feed pellet having a variety of lengths with virtually all of the fibers being shorter than the overall length of the pellet.

Another process used for adding continuous, parallel and aligned fiber reinforcing to the center of a plastic product involves pulling the fiber over several directional rollers, through some form of resin bath containing a molten polymer to fully wet the fibers and subsequently through a heating process and a final forming die. This method of feeding the fibers, however, requires multiple steps employing large equipment and is difficult to use when the fibers to be incorporated are brittle and susceptible to frequent breakage thus causing a great deal of machine down time and interruptions in the continuity of the fiber within the product. Although many types of reinforcing fiber can withstand this process and be incorporated into a final product that satisfies the final desired result of a fiber reinforced product, the type of fiber that must be incorporated in to the plastic in the field of thermally conductive plastics is very application specific and tends to be brittle.

In view of the foregoing, there is a demand for a composite material that is reinforced with continuous fibrous filler. In addition, there is a demand for a method of producing a composite thermally conductive material that contains continuous fiber reinforcing that can be molded into complex product geometries. There is also a demand for a highly thermally conductive polymer composite material that can be injection molded while providing a uniform distribution of long fiber reinforcing in the completed part and exhibiting thermal conductivity as close as possible to purely metallic conductive materials while being relatively low in cost to manufacture.

### SUMMARY OF THE INVENTION

In this regard, the present invention provides for the extrusion of a thermally conductive polymer composition containing a continuous core of carbon fiber reinforcing. The material is created in a machine that is configured to hold a spool containing a continuous strand of carbon fiber core material. The carbon fiber strand is unrolled off the spool and is fed into a preheating chamber to bring the temperature of the strand to a pre-designated level. The strand is then fed into a port in an extruding head on a pressure extruding machine. A molten polymer matrix is also fed into the extruding head thereby extruding the polymer matrix onto, around and between the individual carbon fibers contained in the strand. The singular extruded composite strand that emerges from the extrusion head is then cooled and deionized before cutting the composite strand into pellets of a desired length for further processing and use as injection molding feedstock.

The machine and the manufacturing method and composite material of the present invention provides a highly thermally conductive polymer composite for use in molding applications that overcomes the limitations of the prior art by providing an inexpensive method for creating material that is preloaded with a consistent distribution of conductive fibers that have a relatively high aspect ratio and eliminates the mixing process for incorporating conductive fibers into the base matrix prior to injection molding. The present invention therefore also provides for an injection molding material that has high uniformity and can be used to produce a net shape molded, thermally conductive polymer part with a highly predictable thermal conductivity.

Accordingly, among the objects of the present invention is a method for producing pelletized injection molding feedstock having continuous reinforcing fibers therein. Another object of the present invention the provision of a low cost method for producing injection molding pellets having continuous thermally conductive fibers extending along the entire length of each of the pellets. Another object of the present invention is the production of a thermally conductive composite polymer material that includes continuous lengths of reinforcing fibers.

Other objects, features and advantages of the invention shall become apparent as the description thereof proceeds when considered in connection with the accompanying illustrative drawings.

### BRIEF DESCRIPTION OF THE DRAWINGS

In the drawings which illustrate the best mode presently contemplated for carrying out the present invention:

FIG. 1 is a side elevational view of the apparatus for carrying out the method of the present invention;

FIG. 2 is a partially cut-away view of the extruded material made in accordance with the method of the present invention; and

FIG. 3 is a perspective view of the pelletized extrusion of the present invnetion.

### DETAILED DESCRIPTION OF THE INVENTION

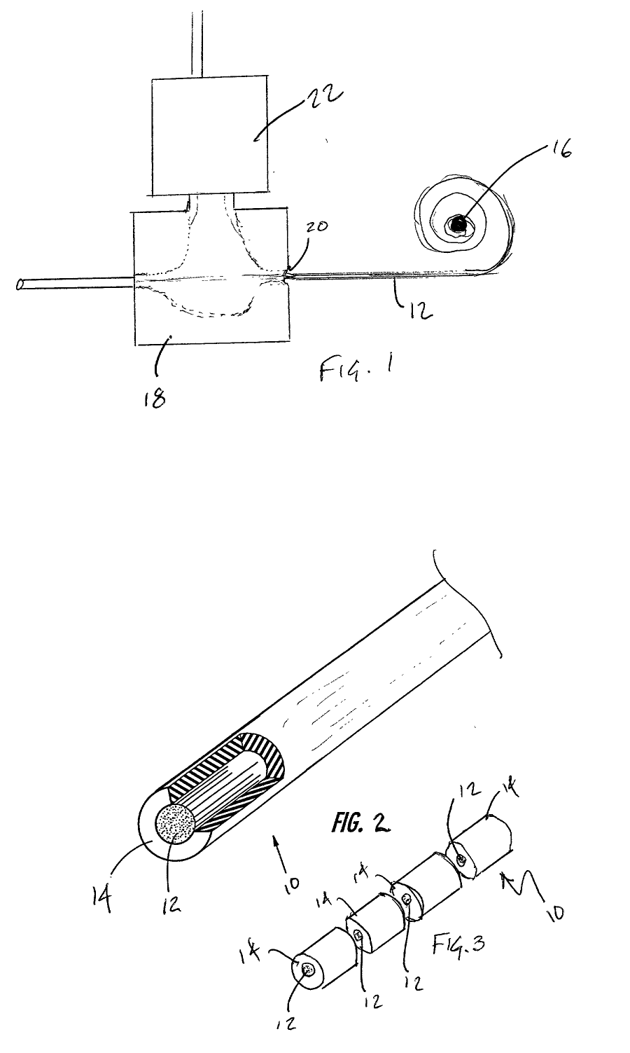

Referring now to the drawings, an elevational view of the method of the present invention is illustrated and generally shown in FIG. 1. The composite polymer material of the present invention is illustrated and generally shown in FIGS. 2 and 3. As will hereinafter be more fully described, the present invention provides for the formation of polymer bodies 10, as shown in FIG. 3, having continuous fiber 12 reinforcing throughout the body 10 or as a core within body 10. The composition and method of the present invention allow the incorporation of continuous brittle reinforcing fibers 12 into a polymer composition that are suitable for further processing and injection molding while maintaining the continuity of the fibers 12.

The preferred use of the present invention is to produce thermally conductive plastic feedstock material 10 for use in net shape molding of thermally conductive plastic parts. The fiber reinforcing 12 used in the present invention therefore is typically carbon fiber. Carbon fiber material is highly thermally conductive and when employed as a filler in highly filled polymer compositions imparts a high level of thermal conductivity to the completed part. The drawback however is that the carbon fiber is brittle and susceptible to breaking when handled. The present invention provides a manner for producing injection-molding feedstock 10 that incorporates relatively long pieces of carbon fiber 12 while reinforcing them to reduce the amount of breakage during subsequent handling and molding operations.

For this application, the feedstock 10 preferably includes fiber 12 of a pitch-based carbon fiber in a liquid crystal polymer 14 base. Such materials are preferred for forming feed stock material 10 for thermally conductive applications. Other materials may be employed and still be within the scope of the present invention. For example, PAN-base carbon fiber may be used in a polymer base matrix for high strength applications.

In accordance with the method of the present invention, a spool 16 containing a strand of reinforcing fiber 12 is arranged to smoothly feed the reinforcing fiber 12 into a pressure extruding head 18. The fiber strand 12 is a single continuous strand that is made from several individual fibers in a non-woven fashion. The fiber strand 12 is arranged so that the leading end of the fiber is inserted into an input port 20 in the extrusion head 18 of a pressure driven extrusion machine. The fiber strand 12 is preheated to a predetermined temperature before the extrusion process is started. The purpose of preheating the fiber 12 is to enhance the wetting process as will be described below. A molten polymer base matrix 14 is pressure injected into the extrusion head 18 using a pressure injection ram 22 where the polymer 14 comes into contact with the reinforcing strand 12 and flows around the strand 12 and between the individual fibers of the strand 12 serving to individually encapsulate and wet out each of the individual fibers. An important feature of the present invention is the preheating of the strand 12 before the introduction of the molten polymer 14. By preheating the strand 12, the temperature of the strand 12 is more closely matched to the temperature of the molten polymer 14 that is injected into the extrusion head 18. Since the temperatures are similar, the wet out of the fibers in the strand 12 is improved because the polymer 14 is maintained at a low viscosity as compared to if the strand 12 had not been heated, causing a cooling effect when the polymer 14 contacted the strand 12 and increase in the viscosity of the polymer material 14. In this manner, the fibers within the strand 12 are more thoroughly wet out and covered by the polymer matrix 14, which forms a protective layer 14 around the outer surface of the fibers 12 preventing them from being broken during the subsequent processing steps. As a result, as seen in FIGS. 2 and 3, the material 10 extruded from the output end of the extrusion head 18 has continuous strands of carbon fiber 12 throughout the entire length of the extrusion 10.

Once the extruded feedstock 10 is cooled it is further fed into a conventional pelletizing device as is well know in the prior art. The extruded material 10 is cut, using the appropriate blades known in the art, into reinforced polymer pellets 10 of a desired length having continuous fiber reinforcing 12 corresponding to the overall length of the pellet 10. The pellets 10 are the extrusions 10 as described above but cut to length. For case of illustration, the pellets and the extrusions are both generally referenced as 10. This is an advantage over prior art compositions and methods that use strands of discontinuous length fibers to extrude a product that is further pelletized. In the prior art cases, there is no way of predicting the length of fiber within the finished pellet and in a high percentage of the distribution, the length of the fibers is less that the overall length of the pellet. In an alternate step, the extruded material may be deionized prior to cutting it to the desired length pellets.

It can therefore be seen that the instant invention provides a novel device for forming thermoplastic bodies having continuous fiber reinforcing throughout their entire length. The pellets 10 provide a superior feed stock for injection molding applications where the use of long thermally conductive fibers is indicated. Specifically, the pellets 10 contain lengths of carbon fiber 12 that have a predictable length for incorporation into the finished product. Further, since the fibers 12 have been wet out with the polymer material 14 they are more stable and les succeptible to breaking during further processing and handling. When injected into a mold cavity in a subsequent net shape molding process, a uniform distribution of relatively long fibers throughout the entire finished product.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A thermally conductive polymer pellet for use as a feed stock in a net shape molding process, comprising:
a continuous reinforcing strand, said strand including a plurality of substantially parallel and aligned non-woven fibers;
a polymer matrix material extruded around said reinforcing strand and between said plurality of fibers, said continuous reinforcing strand and said polymer matrix being cut into a plurality of pellets of a predetermined length.

2. The thermally conductive pellet of claim 1, wherein said continuous strand of fiber reinforcing is carbon fiber.

3. The thermally conductive pellet of claim 1, wherein said polymer matrix material is thermoplastic material.

4. The thermally conductive pellet of claim 3, wherein said thermoplastic material is liquid crystal polymer.

5. A method of producing reinforced polymer material, comprising:
providing a molten base polymer matrix;
providing a continuous strand of reinforcing fiber having a leading end;
providing a pressure extrusion head having an input port and an output port;
heating said reinforcing fiber strand to a predetermined temperature;
inserting the leading end of said reinforcing fiber strand into said input port in said pressure extrusion head; and
injecting said polymer matrix in a continuous flow through said pressure extrusion head, whereby said continuous flow of molten polymer impregnates said reinforcing fiber strand thereby producing a continuous composite extrusion;
cooling said composite extrusion; and
pelletizing said cooled composite extrusion.

6. The method of claim 5 where said step of providing a continuous strand of fiber reinforcing further comprises providing a strand of carbon fiber.

7. The method of claim 5 where said step of providing a providing a molten polymer base matrix further comprises providing molten liquid crystal polymer.

8. The method of claim 5 further comprising the step of deionizing said composite extrusion after said step of cooling said composite extrusion.

9. A method of net shape molding a thermal transfer component using a thermally conductive polymer composition, comprising:
providing a molten base polymer matrix;
providing a continuous strand of reinforcing fiber having a leading end;
providing a pressure extrusion head having an input port and an output port;
heating said reinforcing fiber strand to a predetermined temperature;
inserting the leading end of said reinforcing fiber strand into said input port in said pressure extrusion head; and
injecting said polymer matrix in a continuous flow through said pressure extrusion head, whereby said continuous flow of molten polymer impregnates said reinforcing fiber strand thereby producing a continuous composite extrusion;
cooling said composite extrusion;
pelletizing said cooled composite extrusion to produce composite pellets;
melting said composite pellets to form a molten composite material; and
injecting said molten composite material into an injection mold cavity to form a net shape molded part.

10. The method of claim 9 where said step of providing a continuous strand of fiber reinforcing further comprises providing a strand of carbon fiber.

11. The method of claim 9 where said step of providing a providing a molten polymer base matrix further comprises providing molten liquid crystal polymer.

12. The method of claim 9 further comprising the step of deionizing said composite extrusion after said step of cooling said composite extrusion.
